(19) United States
(12) Patent Application Publication
(10) Pub. No.: US 2012/0047274 A1
(43) Pub. Date: Feb. 23, 2012

(54) METHOD FOR MANAGING DATA BETWEEN MOBILE DEVICES AND PERSONAL COMPUTER

(75) Inventor: Johnny Chen, Santa Ana, CA (US)

(73) Assignee: I/O INTERCONNECT, LTD., Santa Ana, CA (US)

(21) Appl. No.: 13/208,688

(22) Filed: Aug. 12, 2011

Related U.S. Application Data
(60) Provisional application No. 61/374,690, filed on Aug. 18, 2010.

(51) Int. Cl. G06F 15/16

(52) U.S. Cl. 709/228

(57) ABSTRACT

An operation method for a mobile device is provided by the present invention. First, a data transmission link is established with a personal computer installing into a personal computer via a network. When a operation is executed, it is checking whether or not a predetermined folder in the mobile device has a predetermined data to be saved into the personal computer. When the predetermined data to be saved into the personal computer, the predetermined data is transmitted to the personal computer. Then, a requirement command is sent to the personal computer through the data transmission link, so as to control the personal computer to save the predetermined data.

### CROSS-REFERENCE TO RELATED APPLICATIONS

The application claims priority of U.S. provisional patent application Ser. No. 61/374,690 filed on Aug. 18, 2010, the contents of which are hereby incorporated by reference.

### FIELD OF THE INVENTION

The present invention relates to a file management technology, and more particularly to a file management technology for a mobile device.

### BACKGROUND OF THE INVENTION

The technological progress until now, the computer unifies early with people's life. No matter is on the basic necessities of life, the assistance from the computer is seen everywhere, so as to make the computer becoming an indispensable helper. In addition, because the technology adds fuel to the flames, it is usually seen that people use the computer everywhere, especially the smart phone combining the cell phone and the tablet computer as a real book.

Since the smart phone and the tablet computer developed currently have almost the same functions with normal notebook computer and have light and thin design, those are more suitable for the environment requiring immediate, so as to be loved by users. Although the storage spaces of the smart phone and tablet computer is less than normal desktop computer and notebook computer, the problem of insufficient storage capacitance is solved by integrating the cloud computing technology which also allows the user accessing other information anytime.

FIG. 1 is a schematic diagram of current file sharing system. Referring to the FIG. 1, in the file sharing system 100, when a user need to backup some data saved in the smart phone 102, the user can operate the smart phone 102 linking with the internet 104. Then, the user can upload the data requiring backup to a cloud server 106 via the internet. Therefore, when the user want to use other apparatus to access the backup data saved in the cloud server 106, the user can use the apparatus, such as the tablet computer 108 or a personal computer 110, to link with the internet 104, so as to download the backup data from the cloud server 106 to the tablet computer 108 or the personal computer 110.

Although the current file sharing system 100 seems to solve the insufficient storage capacitance of the smart phone 102 and provide a platform to different computing apparatus to share data, the network security is a key problem. Because the domination of the cloud server 106 is not belonging to the user, the user may worry about the security of the cloud server, so as to affect the user's willing to backup data on the cloud server 106. Therefore, the problem of insufficient storage capacitance of the smart phone 102 is still existed.

### SUMMARY OF THE INVENTION

Therefore, the present invention is to provide a plurality of operation methods for a mobile device, which can manage the file on a mobile device.

In addition, the present invention provides a method for controlling a personal computer, for dealing with a file from a mobile device.

An operation method for a mobile device is provided by the present invention. First, a data transmission link is established with a personal computer installing into a personal computer via a network. When a operation is executed, it is checking whether or not a predetermined folder in the mobile device has a predetermined data to be saved into the personal computer. When the predetermined data to be saved into the personal computer, the predetermined data is transmitted to the personal computer. Then, a requirement command is sent to the personal computer through the data transmission link, so as to control the personal computer to save the predetermined data.

In one embodiment of the present invention, the step of transmitting the predetermined data comprises copying the predetermined data in the mobile device to generate a copied data, when the requirement operation is a mapping requirement operation. Then, moving the copied data to the personal computer through the data transmission link, so as to save the copied data into the personal computer.

In addition, the step of transmitting the predetermined data comprises moving the predetermined data to the personal computer through the data transmission link directly, when the requirement operation is a archive requirement operation, so as to save predetermined data into the personal computer.

In one embodiment of the present invention, the step of establishing the data transmission link is to establish the data transmission link to an application program installed into the personal computer.

From another viewpoint, a method for controlling a personal computer is provided that a plurality of data transmission links are established through a network with a plurality of mobile devices respectively. Therefore, the personal computer is controlled according to a requirement command sent from at least one of mobile devices through corresponding data transmission link.

In one embodiment of the present invention, the personal computer can save a transmitted data from the corresponding application program into a predetermined folder according to the requirement command.

Since the computer can save the transmitted data from the corresponding application program, the storage capacitance of the mobile device can be extended.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram of current file backup system.

FIG. 2 is a schematic diagram of a system for managing data according to one preferred embodiment of the present invention.

FIG. 3 is a block diagram of a mobile device according to one preferred embodiment of the present invention.

FIG. 4 is a schematic diagram of the file management menu according to one preferred embodiment of the present invention.

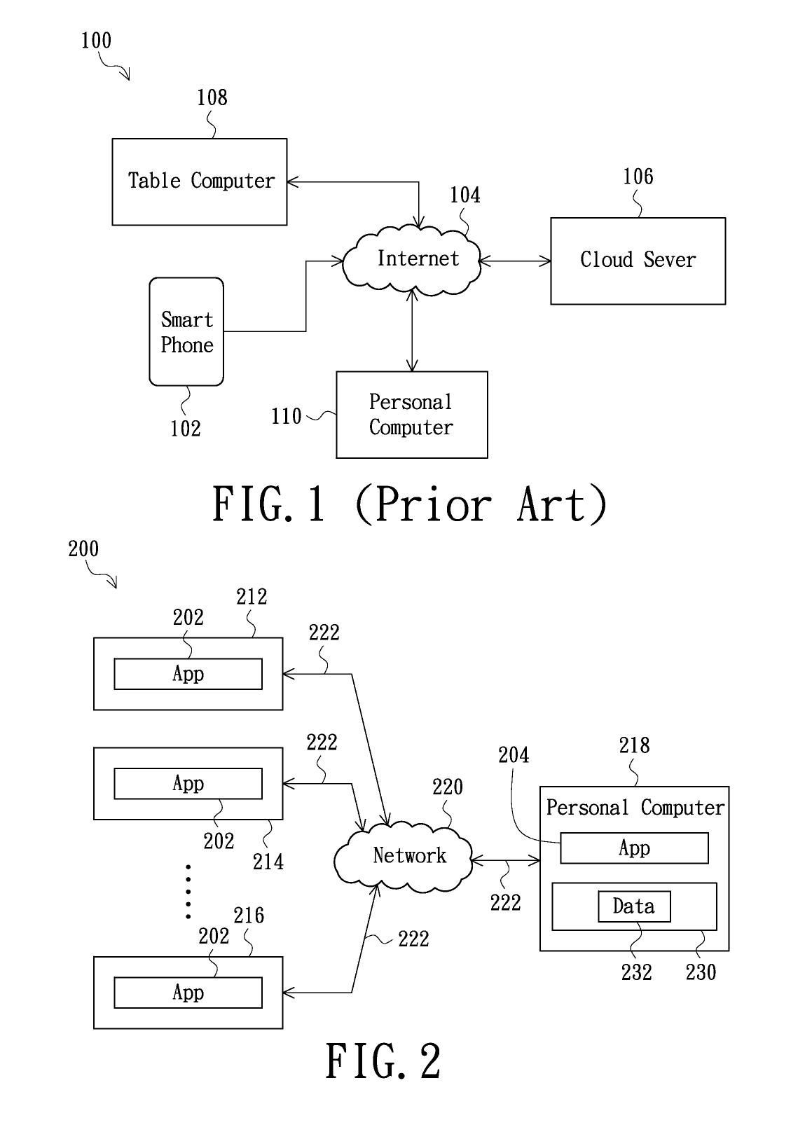

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

FIG. 2 is a schematic diagram of a system for managing data according to one preferred embodiment of the present invention. The system 200 comprises a plurality of application programs 202 and an application program 204. The application programs 202 are installed into a plurality of mobile devices, such as 212, 214, and 216, respectively. In addition, the application program 204 is installed into a personal computer 218, such like a desktop computer, or a notebook computer. In this embodiment, a plurality of data transmission links are established between the mobile devices 212, 214 and 216 are the personal computer 218 through the network 220. In some embodiments, the network 220 is the internet.

In this exemplary embodiment, the application programs 202 could transmit a requirement command to the application program 204 through the data transmission links 202. Therefore, the personal computer 218 would work according to the requirement command.

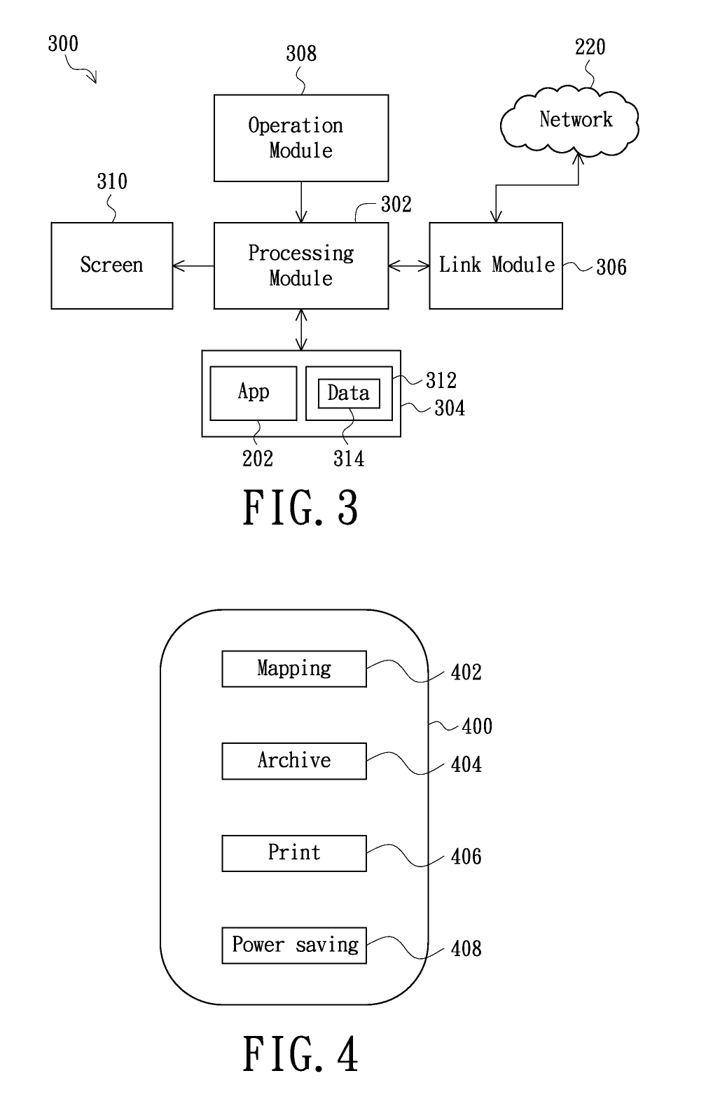

FIG. 3 is a block diagram of a mobile device according to one preferred embodiment of the present invention. Referring to the FIG. 3, the mobile device 300 of this embodiment can be any of the mobile devices 212, 214 and 216 shown in the FIG. 2. The mobile device 300 is probably a smart phone, a tablet computer, a packet computer, a multi-media player, etc. The mobile device 300 has a processing module 302, a storage unit 304 and a link module 306. Wherein, the processing module 302 is coupled to the storage unit 304 and the link module 306. The storage unit 304 is probably a flash memory or a memory card. Furthermore, the link module 306, such as a WiFi link module, a mobile 3G link module, a LTE link module, a TD-LTE link module, and a WiMax link module, is linked to the network 220.

In some embodiments, the application program 202 is installed into the storage unit 304. In addition, the storage unit 304 has a predetermined folder 312, in which a predetermined data 314 is saved. In this exemplary embodiment, the predetermined data 314 can be a sub-folder or a single file, such like a video file, a photographic file, a music file, a document file, or an e-mail.

Furthermore, the mobile device 300 has an operation module 308 and a screen 310. The operation module 308 has at least one of operation unit, such as a real key, a touch-control panel, a joystick, a roll wheel, or a track ball. In addition, the screen 310 is probably a touch-control screen panel.

When the application program 202 is started, the application program 202 would establishes a data transmission link with the personal computer 218 basis on the network 220. When the data transmission link is established, the application program 202 can communicate with the application program 204. Then, the control means 212 would provide a file management menu on the screen 310.

FIG. 4 is a schematic diagram of the file management menu according to one preferred embodiment of the present invention. The file management menu 400 of this embodiment has a plurality of items, such as a mapping item 402 for a mapping requirement operation, an archive item 404 for an archive requirement operation, a print item 406 for a print requirement operation, and a power saving item 408 for a power saving requirement operation.

### Mapping Requirement Operation

The following description is more detail to describe the mapping, the archive, the print, the power saving requirement operations. Referring to the FIGS. 2 to 4, when the mapping item 402 in one of the mobile devices is selected, the mapping requirement operation is executed. Meanwhile, the corresponding application program 202 would search whether or not a predetermined folder in the corresponding mobile device has at least one predetermined data to mapped to the personal computer 218.

In this embodiment, if the predetermined folder 312 has the predetermined data 314 require mapping to the personal computer 218, the corresponding application program 202 would copy the data 312 to generate a copied data. Then, the corresponding application program 202 controls the processing module 302 moving the copied data of the predetermined data 314 to the personal computer 218 via the data transmission link 222 from the link module 306. Additionally, the corresponding application program 202 further sends a mapping requirement command to the application program 204. So that, the application program 204 would control the personal computer 218 saving the copied data of the predetermined data 314 for responding the mapping requirement command. In some embodiment, the application program 204 would control the personal computer to save the copied data of the data 314 into a predetermined folder, such as the folder 230.

For example, when a user uses the smart phone taking some photographic, and saving into the smart phone. The user can execute the mapping requirement operation to make a copied data into self's personal computer 218 without passing another server. Therefore, the present invention can improve the network security and extend the storage capacitance of the mobile devices.

In addition, when the application program 204 receives the mapping requirement command from corresponding application program 202, the application program 204 also search whether or not a predetermined folder in the personal computer 218, such as the folder 230, has a predetermined data to be mapped the corresponding mobile device which sends the mapping requirement command. When the application program 204 determines that the predetermined folder 230 has a predetermined data, such as the data 232, to be mapped to the corresponding mobile device, the application program 204 also copies the data 232 to generate a copied data and sends the copied data to the corresponding application program 202 via the corresponding data transmission link 222. Meanwhile, the corresponding application program 202 would control the processing module 302 to save the copied data of the data 232 into the storage unit 304. Wherein, the type of the data 232 likes the type of the data 314.

As the above mentioned, the mapping action in the present embodiment is bi-direction between the mobile devices and personal computer. Moreover, the embodiment can implement the mapping action of one-to-many (i.e. the computer 218 to all of the mobile devices).

As the above maintain, a user can uses a fist mobile device, such as a smart phone, to map the predetermined data to the personal computer. Then, the user can obtain the predetermined data through a second mobile device, such like the tablet computer. Therefore, the present invention can implement sharing data among different mobile devices. Furthermore, applying the above technology, the present invention also can recovery a damage data of the mobile device, because the backup of the predetermined data is saved into the personal computer 218.

### Archive Requirement Operation

When the archive item 404 is selected, the archive requirement operation is executed. Similar with the mapping requirement operation, the application program 202 also searches whether or not the predetermined folder 312 has a predetermined data to backup to the personal computer 218. Different from the mapping requirement operation, when the application program 202 determine the data 314 to backup to the personal computer, the application program 202 would control the processing module moving the predetermined data 314 to the personal computer 218 via the network 220 from the corresponding data transmission link 222. In addition, the application program 202 also sends an archive requirement command to the personal computer. Meanwhile, the application program 204 would control the personal computer saving the data 314 for responding the archive requirement command.

The difference between the mapping requirement operation and the archive requirement operation is that the predetermined data is still saved into the corresponding mobile device. In the mapping requirement operation, both the mobile devices and the personal computer have the predetermined data. On the contrary, when the archive requirement operation is executed, the predetermined data is moved from the mobile devices. Meanwhile, only the personal computer 218 has the predetermined data. Therefore, the storage spaces of the mobile devices can be saved.

### Print Requirement Operation

When the print item 406 is selected by the user, the print requirement operation is executed. Meanwhile, the application program 202 also searches whether or not the predetermined folder 312 has a predetermined data to be printed out. If the application program 202 determines that the folder 312 has the predetermined data, such as the data 314, to be printed, the application program 202 would copy the data 314 to generate a copied data. Then, the application program 202 controls the processing module 302 sending the copied data of data 314 to the personal computer 214 through the corresponding data transmission link 222 from the link module 306.

In addition, the application program 202 further sends a print requirement command to the application program 204. Therefore, the personal computer 218 is controlled by the application program 204 to perform a print procedure, for example, driving a printer to print the copied data of the data 314. Therefore, a user can remote controls the personal computer to print the photographic, picture, image, document, or e-mail.

### Power Saving Requirement Operation

When the power saving item 408 is selected, the application program 202 would generate a power saving requirement command. The power saving requirement command is sent to the personal computer 218 via the network 220. When the application program 204 receives the power saving requirement command, the personal computer 218 is controlled by the application program 204 to enter a power saving mode.

In some embodiments, when the personal computer 218 enters the power saving mode, the application program 204 makes the personal computer 218 maintaining that the mobile devices can access data with the personal computer 218 anytime. Therefore, even the personal computer 218 enters the power saving mode, the mobile devices can execute other requirement operation with the personal computer 218.

In summary, the present invention can solve the problem of finite storage space of the mobile device through copying or moving the predetermined between the mobile device and the personal computer. Since the personal computer is belonging to the user self, the network security is improved. In addition, the present invention further provides the user to remote control the personal computer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation method for a mobile device, comprising:
establishing a data transmission link with a personal computer via a network;
checking whether or not a predetermined folder in the mobile device has a predetermined data to be saved into the personal computer for responding a requirement operation;
transmitting the predetermined data to the personal computer, when the predetermined data to be save into the personal computer; and
sending a requirement command to the personal computer through the data transmission link, so as to control the personal computer to save the predetermined data.

2. The operation method according to the claim 1, wherein the step of transmitting the predetermined data comprises:
copying the predetermined data in the mobile device to generate a copied data, when the requirement operation is a mapping requirement operation; and
moving the copied data to the personal computer through the data transmission link, so as to save the copied data into the personal computer.

3. The operation method according to the claim 1, wherein the step of transmitting the predetermined data comprises:
moving the predetermined data to the personal computer through the data transmission link, when the requirement operation is a archive requirement operation, so as to save predetermined data into the personal computer.

4. The operation method according to the claim 1, further comprising:
sending a print requirement command to the personal computer through the data transmission link as a print requirement operation being executed, so as to control the personal computer executing a print procedure to print the copied data.

5. The operation method according to the claim 1, further comprising:
sending a power saving requirement command to the personal computer through the data transmission link for responding a power saving requirement operation, so as to control the personal computer entering a power saving mode.

6. The operation method according to the claim 1, wherein the step of establishing the data transmission link comprises:
establishing the data transmission link with an application program installed into the personal computer.

7. A method for controlling a personal computer, comprising:
establishing a plurality of data transmission links through a network with a plurality of mobile devices respectively; and
saving a predetermined data transmitted from one of the mobile devices into a first predetermined folder for responding a requirement command from the corresponding mobile device, when a second predetermined folder in the corresponding mobile device has the predetermined data to be saved into the personal computer.

8. The method according to the claim 7, wherein the step of controlling the personal computer comprises:
determining whether or the first predetermined folder has the predetermined data to be mapped to the corresponding mobile, when the requirement command is a mapping requirement command;
copying the predetermined data to generate a copied data, when the first predetermined folder has the predetermined data to be mapped to the corresponding mobile device; and
moving the copied data to the corresponding mobile device through the corresponding data transmission link, so as to make the corresponding mobile device saving the copied data for responding the mapping requirement command.

9. The method according to the claim 7, wherein the step of controlling the personal computer comprises:
executing a print procedure to print the predetermined data from the corresponding mobile device, when the requirement command is a print requirement command.

10. The method according to the claim 7, wherein the step of controlling the personal computer comprises:
entering a power saving mode, when the requirement command is a power save requirement command.

11. The method according to the claim 7, wherein the step of establishing the data transmission link comprises:
establishing each data transmission link with an application program, wherein each application program is installed into one of the mobile devices respectively.
